(19) United States
(12) Patent Application Publication
(10) Pub. No.: US 2007/0215817 A1
(43) Pub. Date: Sep. 20, 2007

(54) Fluorescence detection system

(76) Inventors: Masataka Shirai, Higashimurayama (JP); Takashi Anazawa, Koganei (JP); Chihiro Uematsu, Kawasaki (JP); Chifumi Gouda, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/705,446

(22) Filed: Feb. 13, 2007

(30) Foreign Application Priority Data
Mar. 15, 2006 (JP) 2006-071641

(51) Int. Cl. G01N 21/64

(52) U.S. Cl. 250/458.1

(57) ABSTRACT

Single molecular measurement is conducted with a high throughput. Fluorescence from labeled target molecules flowing a sample flow cell is measured by a line CCD element to realize single molecular measurement with a high throughput. Where, the number of photo detecting pixels of the line CCD element is smaller than a value obtained by dividing an exposure time by pixel transfer rate.

### CLAIM OF PRIORITY

The present application claims priority from Japanese application JP 2006-071641 filed on Mar. 15, 2006, the content of which is hereby incorporated by reference into this application.

### BACKGROUND OF THE INVENTION

1. Field of the Invention

The present invention relates to a fluorescence detection system, and in particular, to a fluorescence detection system suited for determining trace amounts of a biological material such as DNA and RNA collected from, for example, an organism not through a chemical amplification process.

2. Description of the Related Art

A chemical amplification such as a polymerase chain reaction (PCR) method is generally used for determining trace amounts of a biological material. When the chemical amplification is used, products after having been amplified are determined to estimate the amount of a biological material before being amplified. However, an amplification factor is inevitably dispersive, so that the estimated value of determined biological-material will be inaccurate. To solve this problem, it is desirable to directly determine trace amounts of a biological material. Single molecular measurement is one of methods for realizing the above.

The “single molecular measurement” refers to a method in which a fluorescent label is bonded to a biological material to be determined and excited by laser beams to count fluorescence labeled molecules (refer to a non-patent document 1, for example). The non-patent document 1 states that about 1000 DNA molecules in a sample solution of 0.3 μL can be detected. FIG. 1 shows the configuration of a detecting system which realizes the conventional method. A laser beam 5 for exciting fluorescence labeled molecules is emitted from a laser beam source 1, passes through a shutter 2 for adjusting exposure time, focused by a lens 3 and falls on a capillary 12. The capillary is filled with sample solution including a biological material (hereinafter referred to as “target”) to be determined. The target is fluorescently labeled before it has been introduced to the capillary 12. For this reason, if the sample solution includes targets, they are irradiated with laser beams to produce fluorescence. At this point, targets are dispersed in the sample solution, the targets at an area (a volume of 5×10⁻¹¹ L) of the capillary irradiated with laser beams appear as dotted luminous bodies. An image in the area irradiated with laser beams is formed on a charge coupled device (CCD) 8 in a camera 7 by an objective lens 6 to detect such luminous bodies, whereby luminous images are obtained. The luminous bodies in the detected data are identified from background in the area irradiated with laser beams and counted to determine fluorescence labeled target molecules.

FIG. 2 is an enlarged view of the area irradiated with laser beams in the capillary. The capillary 12 which is filled with sample solution and rectangular in cross section is irradiated with laser beam 13 whose spot is shaped to ellipse by two cylindrical lenses. A laser irradiation volume 16 is a shape extended toward the flow of the sample solution shown in the figure. That is to say, as shown in FIG. 2, a laser irradiation (spot) width 17 is made longer than a laser irradiation height 18. The reason is that, if the laser irradiation height 18 is excessively high, fluorescent images are blurred to be less turned to dots, resulting in decrease in sensitivity. The cross section of the capillary is approximately 50 μm in width 19. Although it is possible to increase a measuring volume by increasing the width, it is difficult to flatten the cross section, so that only the width is not excessively increased. Increasing the cross section of the capillary in height 20 increases blurred fluorescent images, as mentioned above, decreasing background, which results in decrease in sensitivity. The fluorescence labeled target 14 is electrophoresed in the direction of an arrow 15 at a rate of 90 mm/sec.

As can be seen from FIGS. 1 and 2, an electrophoresis direction 15 is perpendicular to the direction 5 of laser-beam incidence. This is a configuration required to measure the concentration of electrophoresed fluorescence labeled target molecules by a moving distance. Such a configuration is also disclosed in patent documents 2 to 6. In these known examples, gel is inserted into two glass substrates to separate molecules in the gel by molecular size by using electrophoresis. The fluorescence labeled target molecules separated by molecular size are excited by the laser beams passing between two glass substrates to determine the concentration by molecular size by fluorescent measurement.

In the methods disclosed in the non-patent document 1 and the patent documents 2 to 6, the direction in which fluorescence is measured is set perpendicular to the direction of laser-beam incidence. Patent documents 7 to 9 disclose that the laser-beam exciting direction is perpendicular to the fluorescent measuring direction, although electrophoresis is not used. In the patent document 7 in particular a sample cell is filled with a fluorescent material whose fluorescence is measured or samples including a fluorescent material and laser beams are incident from one end of the sample cell, pass through the inside and outgo from the other end thereof. The sample cell is long in shape in the direction in which laser beams travel and formed by a transparent material such as glass or the like. Using the configuration, the integrated value of fluorescent intensity is detected from the direction substantially orthogonal to pulse excitation light based on a signal synchronized with output timing of the pulse excitation light to calculate a fluorescent lifetime. Patent documents 8 and 9 also state that the space between two glass plates is filled with gel and laser beams are caused to be incident on the inside of the gel from the end of the glass plate. In this configuration, the concentration of fluorescence existing in the gel is measured. The patent document 10 discloses a configuration in which laser beams are caused to be incident on an optical measuring chip and the fluorescence measuring direction is different from the laser-beam incidence direction.

On the other hand, the patent document 1 discloses a system in which sample solution including target is held on the flat face and excited from the other side of the sample solution or from the top face thereof to detect fluorescence from fluorescence labeled target molecules. The document discloses that this system in particular enables samples to be scanned (moved) with respect to a detector to determine the target concentration of a large number of sample solutions by fluorescence detection.

[Patent Document 1] Japanese Translation of Unexamined PCT Appln. No. 2002-528714
[Patent Document 2] Japanese Unexamined Patent Application Publication (JP-A) No. S63-021556
[Patent Document 3] JP-A No. H07-134101
[Patent Document 4] JP-A No. H08-105834
[Patent Document 5] JP-A No. H09-043197
[Patent Document 6] JP-A No. H09-210910
[Patent Document 7] JP-A No. H09-229859
[Patent Document 8] JP-A No. H10-513555
[Patent Document 9] JP-A No. H10-513556

### [Patent Document 10] JP-A No. 2003-177097

[Non-Patent Document 1] Analytical Chemistry, Vol. 74, No. 19, 5033 The problems to be solved by the present invention, or the purpose of the present invention is to accurately determine trace amounts of a biological material in a short time without amplification. In a method of labeling a biological material to be determined with fluorescence and determining the labeled biological material by counting, in particular, the purpose is to accurately determining the material by increasing measuring volume per unit time to almost perfectly count molecules in the volume.

In the configuration disclosed in the non-patent document 1, while the target is moved by electrophoresis to measure the number of target molecules in sample solution, the volume of solution which can be measured at a given time may be realized by increasing an average velocity at which the target moves. However, the target average moving velocity cannot be substantially increased due to the following reason. The increase of the target average moving velocity (in general, the average moving velocity of fluorescence labeled target molecules) turns the dotted fluorescence labeled targets to bar-shaped targets because the targets move by one pixel or more during a exposure time under condition where the exposure time is maintained, as a result, fluorescent amount per pixel is decreased to lower sensitivity, which makes measurement impossible. On the other hand, when the exposure time is shortened so that the image is not turned to be bar-shaped, fluorescent amount is inevitably decreased, lowering sensitivity, which makes measurement impossible. At this point, the excitation laser intensity may also be increased, but a sufficient low price and small laser power source is limited in terms of intensity. That is why the average moving velocity cannot be substantially increased to increase measuring volume per unit time.

In the configuration disclosed in the non-patent document 1, the target is moved in the direction perpendicular to the laser beam irradiation direction to capture the fluorescent image of fluorescence labeled target molecules in sample solution by a CCD in a given time interval. If the time interval is taken to be a frame time, and if the distance over which the target moves during the frame time is not made shorter than the length parallel to the move of target in the solution area corresponding to the image to be measured, unmeasurable target molecules are generated, which makes it impossible to accurately determine the number of target molecules, if the number of target molecules is small. In addition, it takes a long time to output image data captured by the CCD to the outside proportionally to image size, but it needs taking time shorter than the frame time. This implies that if a sufficient sensitivity can be obtained, a measuring volume per unit time cannot be expanded by the limit of data transfer time.

In the configuration disclosed in the patent document 1, since a laser excitation density is decreased in inverse proportion to the area where the sample is irradiated with laser beams, it is difficult to ensure a wider measuring area with sensitivity maintained. The reason is that the expansion of laser irradiation area inevitably decreases the excitation intensity density because the direction in which laser is incident on the sample solution coincides with the fluorescence measuring direction. Actually, a laser irradiation area is of the order of 100 to 10000 mm² in the embodiment in the patent document 1. If the laser irradiation area exceeds that, SN ratio is lowered, which makes it difficult to measure fluorescence from fluorescent body labeled on one target or a group of fluorescent bodies.

In the patent documents 2 to 6, the concentration of fluorescence labeled target molecules separated by electrophoresis according to molecular size is measured by fluorescent intensity. Means such as gel which differentiates average moving velocity of molecules needs to be provided between the cells (glass plate) holding samples so that the average moving velocity of molecules in sample solution varies with molecular size and electric charge. At this point, when the sample solution is moved in the cell, the gel essentially needs to be stopped with respect to the cell. For this reason, in the patent documents 2 to 6, when the sample solution is moved in the cell, the sample solution in the cell is not uniform. Making the sample solution ununiform enables separately detecting specific molecules. In the patent documents 8 and 9, gel for electrophoresis requires to be inserted between two glass plates and the sample solution in two glass plates is ununiform as is the case with the patent documents 2 to 6.

The patent document 7 aims at measuring the lifetime of fluorescent material, so that laser beams are propagated in the sample solution by using pulse laser to measure the distribution of intensity of fluorescence different in an exciting start time. Therefore, there is not provided means for moving the sample solution perpendicularly to the exciting laser beams. In the patent document 10, the laser beam irradiation direction is made perpendicular to the fluorescent measuring direction. However, a photodetector is for measuring the intensity and wavelength of fluorescence, not for measuring the distribution of fluorescent intensity or a fluorescent molecular image to enable measuring monomolecules.

As described above, it has been difficult to accurately measure extensive samples for a given time period in measuring monomolecules by using the conventional technique.

### SUMMARY OF THE INVENTION

In the present invention, sample solution including fluorescence labeled molecules is caused to flow through a flat channel greater in width than in height in a flow cell and fine laser beam is emitted perpendicularly to the direction in which the sample solution flows to excite fluorescent labels. A photo detecting device such as a CCD having a rectangular photo detecting section including M-pieces of photo detecting pixels in the direction of the long side of the photo detecting section and N-pieces (M>N) of photo detecting pixels in the direction of the short side thereof is arranged with the long side of the photo detecting section conformed to the direction in which an exciting light propagates. Images in the exciting area are formed on the photo detecting section of the photo detecting device by the objective lens and one-dimensional images outputted from the photo detecting device are coupled with each other in time series to produce two-dimensional fluorescent images.

At this point, measurement is conducted under the condition that a time Tᵣₐₙₛ during which data of electric charges transformed from exposure detected by the M- and N-pieces of photo detecting pixels within an exposure time Tₑₓₚ for the M- and N-pieces of photo detecting pixels are outputted to the outside of the photo detecting device is shorter than the exposure time Tₑₓₚ.

In another embodiment, data of electric charges transformed from exposure detected by the M- and N-pieces of photo detecting pixels within the exposure time Tₑₓₚ are outputted to the outside of the photo detecting device as one unit, and if an average velocity of the sample solution flowing through an area of the channel in the flow cell irradiated with the exciting light is taken to be v, the length of the short side of the photo detecting pixel is taken to be 1p, the magnification of the objective lens is taken to be m, and the average of the number of photo detecting pixels is taken to be Ns when one fluorescent label is detected while spanning a plurality of photo detecting pixels in the direction of the long side on the photo detecting device and, the following condition is satisfied:

(Ns×1p)/(m×Tₑₓₚ)≦v≦(N×1p)/(m×Tₑₓₚ).

In another embodiment of the present invention, there is provided measuring means which measures the size and intensity of fluorescent image in two-dimensional fluorescent images produced by arranging one-dimensional images outputted from the photo detecting device in time series. If there are no photo detecting pixels adjacent to the upstream in the direction of the short side, each of the photo detecting pixels in the photo detecting section of the photo detecting device sequentially transfers electric charges generated by photo detection to the photo detecting pixels adjacent to the downstream in the direction of the short side at a predetermined period, and if there are photo detecting pixels adjacent to the upstream in the direction of the short side, each of the photo detecting pixels sequentially transfers electric charges combined both with charges transferred from the photo detecting pixels adjacent to the upstream and those generated by photo detection by itself to photo detecting pixels adjacent to the downstream in the direction of the short side at a predetermined period. The photo detecting device sequentially outputs the charges as M×1 pieces one-dimensional arrangement data to the outside at the final stage. Furthermore, the transfer period and the flow velocity of sample solution by the sample solution inlet are adjusted based on the size and intensity of fluorescent image in the two-dimensional fluorescent image measured by the measuring means.

According to the invention, it is possible to determine trace amounts of target molecules in sample solution without using chemical amplification in a short time.

### BRIEF DESCRIPTION OF THE DRAWINGS

FIG. 1 is a configuration diagram of a detecting system for realizing a conventional method;

FIG. 2 is an enlarged view of an area irradiated with laser in capillary;

FIG. 3 is an example of a configuration of a fluorescence detection system according to the present embodiment;

FIG. 4 is a schematic diagram of a sample flow cell;

FIG. 5 is a time table of exposure time in an example of an embodiment using a sample flow cell and line sensor;

FIG. 6 is a graph showing the relationship between average flow velocity and sensitivity;

FIG. 7 is an example of a configuration of a fluorescence detection system according to the present embodiment;

FIG. 8 is a schematic diagram of a sample flow cell;

FIG. 9 is an example of an image of fluorescent molecules;

FIG. 10 is a schematic cross section of a sample flow cell;

FIG. 11 a schematic cross section of a sample flow cell using low-refractive index thin film;

FIG. 12 a schematic cross section of a sample flow cell using a dielectric thin film;

FIG. 13 is a schematic diagram of a photo detecting CCD element;

FIG. 14 is a time table obtained for cases where the conditional expression (1) is satisfied;

FIG. 15 is a graph showing measurement results on change in SN ratio with respect to a normalized average velocity.

FIG. 16 is a graph of measurement results on relationship between counts of molecule and concentration;

FIG. 17 is a schematic diagram of a photo detecting CCD element;

FIG. 18 is an example of a configuration of a fluorescence detection system according to the present embodiment;

FIG. 19 is an example of a configuration of a fluorescence detection system according to the present embodiment;

FIG. 20 is a schematic diagram of a sheath flow cell; and

FIG. 21 is a top view of a sample flow cell.

### DETAILED DESCRIPTION OF THE PREFERRED EMBODIMENTS

The embodiments of the present invention are described below.

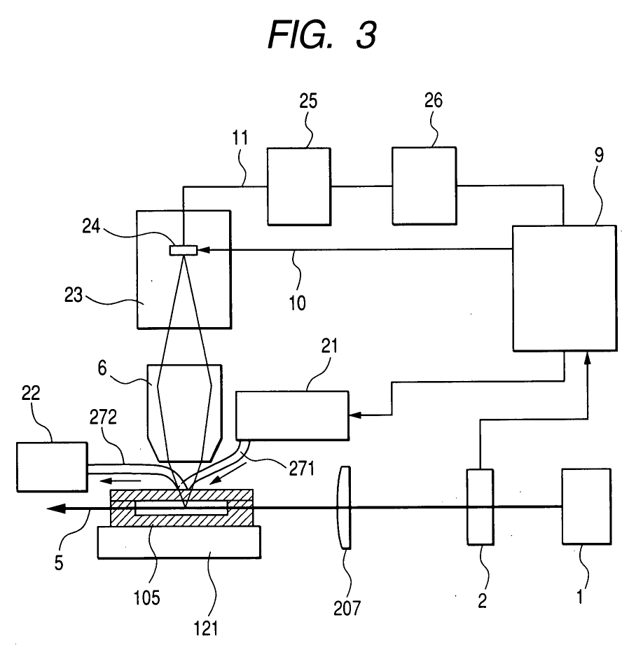

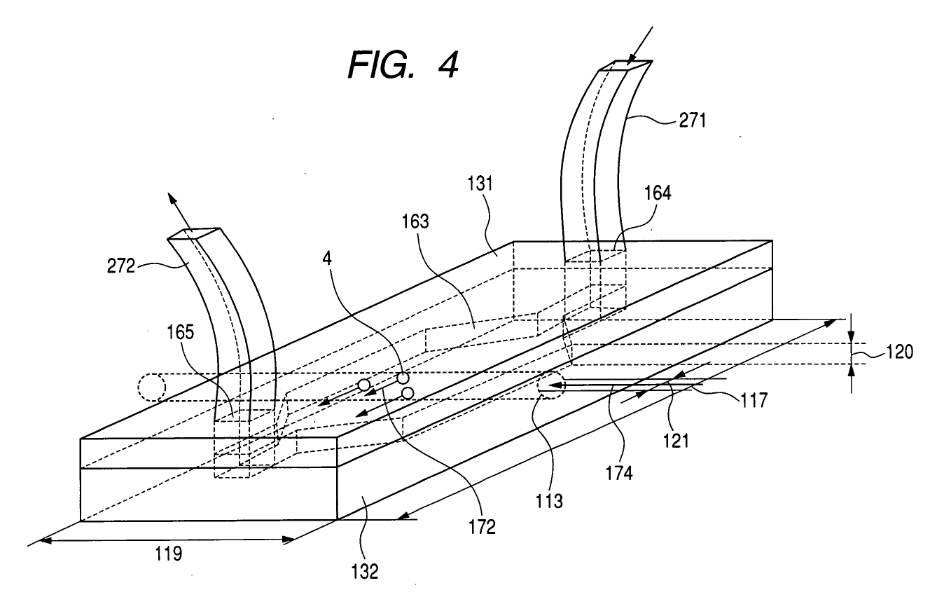

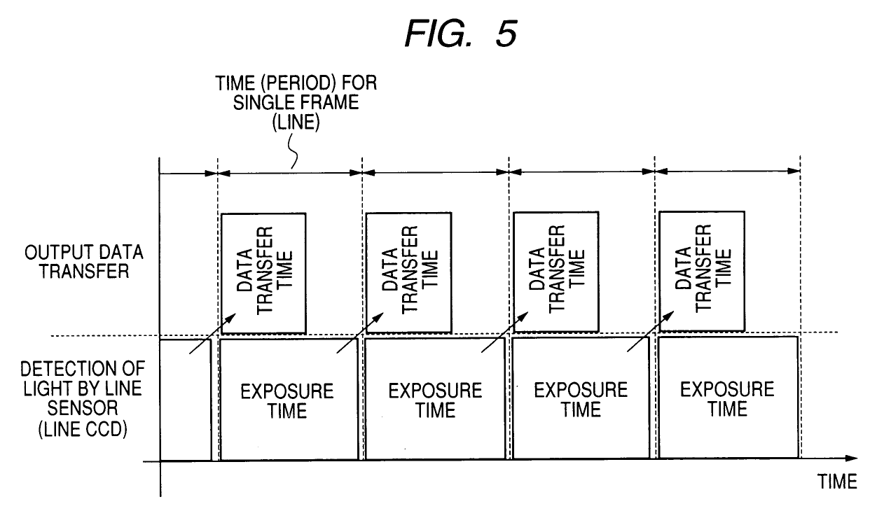

FIG. 3 is a schematic diagram showing an example of a configuration of a fluorescence measuring instrument according to the present invention to realize a high-throughput single molecular measurement. FIG. 4 is a schematic perspective view showing one example of a sample flow cell.

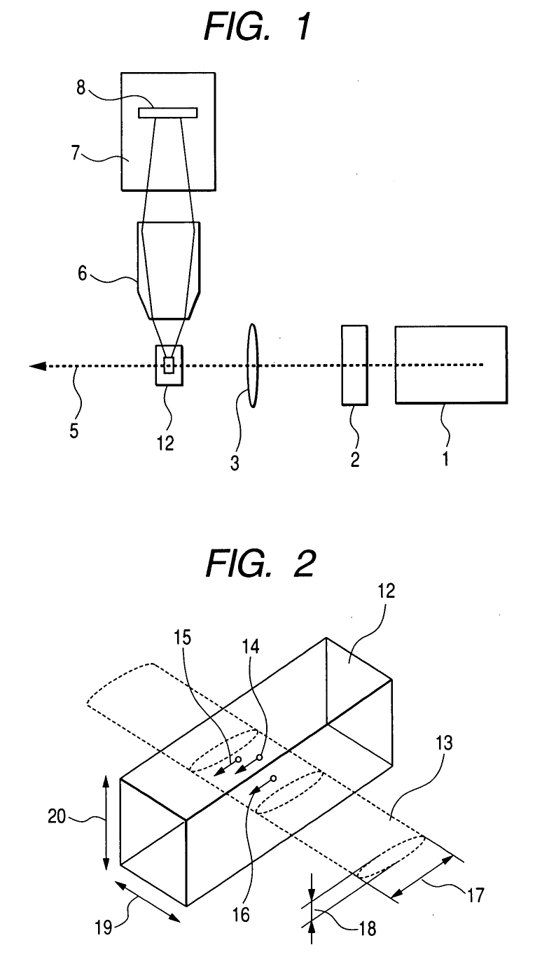

A laser beam 5 from a laser beam exciting source 1 such as Ar⁺ is caused to be incident on the inside of a flow cell 105 where uniform sample solution flows to measure fluorescence from labeled target molecules by a line CCD element 24. The uniform sample solution means that the kinds and concentration of molecules are spatially uniform. In the line CCD element 24, photo detecting pixels are arranged in a rectangular shape instead of a square shape unlike the CCD 8 shown in FIG. 1. The number of pixels is greater on the long side of a rectangle than other side. A shutter 2 properly adjusts an exposure time to excite labeled target molecules. Incidentally, the timing and length of the exposure time may controlled by a control system 9 through a signal line 10 without using the shutter to realize a substantially continuous exposure. An exciting laser beam 5 is focused by a lens 207 and turned into substantially parallel light inside a flow cell 105 (apart where sample solution flows). At this point, an exciting laser density is inversely proportional to a laser spot width 117 (the length is taken as Ls). The exciting laser beam 5 is not extended in the direction 172 in which fluorescence labeled target molecules move, but is made circular to excite a labeled target molecule 4 in a linear area captured by a line CCD camera 23.

A sample flow cell 105 shown in FIG. 4 is composed of two quartz substrates 131 and 132. The flow velocity of the sample solution is controlled by a flow velocity controlling section 21, the sample solution passes through a glass capillary 271, enters the flow cell 105 via a sample channel inlet 164 and flows along a sample channel section 163. The flow velocity controlling section 21 controls labeled target molecules so that the molecules flow along the area of the sample channel section 163 measured by the line CCD 24 at an average velocity v.

The laser beams incident on the sample flow cell 105 propagate between two quartz substrates 131 and 132 and excite fluorescent bodies bonded to fluorescence labeled target molecules in the sample solution flowing between the two quartz substrates. Since a laser propagation distance can be increased up to about several mm, an irradiation area can be extended in the direction in which laser beams propagate to improve throughput. Fluorescence thus generated is focused by the objective lens 6 and imaged on the line CCD element 24. M-pieces of the photo detecting pixels of the line CCD element 24 are arranged parallel to the direction in which the exciting laser beams travel to arrange these pixels perpendicularly to the direction 172 in which the labeled target molecule 4 moves. The number of pixels parallel to the direction in which the target molecule travels is N (M>N).

Fluorescent image data from the line CCD element 24 are outputted to the outside of thereof through a signal line 11. With such a configuration a fluorescent intensity distribution image is continuously obtained from fluorescence labeled target molecules 4 by the line CCD element 24 without time loss and the one-dimensional image is arranged into time series to form again two-dimensional fluorescent intensity distribution image (hereinafter referred to as “two-dimensional fluorescent image”). The number of fluorescence labeled target molecules in the two-dimensional fluorescent image obtained is counted by a particle counting section 26 and outputted as a result to the controlling computer 9. The controlling computer 9 measures the concentration of the target molecules based upon the ratio of the number of fluorescence labeled target molecules to the volume of the sample solution passing through the sample flow cell. Fluorescence labeled target molecules after having been measured pass through the sample flow cell, enter a foul solution reservoir 22 through a sample channel outlet 165 and a glass capillary 272 and collected.

A method of producing a sample flow cell is described as one example. The substrate 132 is etched to make a dent in a part thereof to form a channel between two quartz substrates 131 and 132. The substrate 131 is provided with holes 164 and 165 which are the inlet and outlet of the sample solution and laminated with the substrate 132 and then bonded. The area on the substrate 132 where no etching is made plays the role of a mirror to irradiate the sample solution with the exciting laser beams, so that the inner and outer wall faces thereof are flat mirror plane. FIG. 21 is a top view of the sample flow cell. The sample solution enters the inlet 164, flows along the channel section 163 and then discharged from the sample channel outlet 165.

The sample flow cell was set to several mm or more in width 119 to substantially increase the laser irradiation area compared with the non-patent document 1 and to make it easy-to-handle. The sample flow cell 105 was set to several cm in length 121 from the viewpoint of cost and easy-to-handle requirement because the length is determined irrespective of a sample volume to be measured. The exciting laser spot is decreased to 20 μm from 100 μm in width 117 to improve an exciting laser density by five times, which improved throughput by five times, as described later.

In the next place, a method of improving throughput in single molecular measurement according to the present invention is described below. In single molecular measurement, an optical measuring system needs to be high in sensitivity because fluorescence from one molecule of fluorescence labeled target molecules need to be measured. That is to say, the lower limit determined by the quantum efficiency of a fluorescent body, a laser power and a laser detecting system exists in the exposure time Tₑₓₚ. The conditions for enabling single molecular measurement need to be satisfied and at the same time throughput also needs to be improved. To improve throughput, an average flow velocity requires to be increased as stated later. If the exciting laser irradiation width 117 is taken to be Ls and the average velocity of a labeled target molecule is taken to be v, a time T_{cross} for which a labeled target molecule passes through the irradiation width is T_{cross}=Ls/v. Since a time for capturing fluorescence becomes maximum at T_{cross}, Tₑₓₚ≦T_{cross}.

To measure all the fluorescence labeled target molecules, a time for one period T_{frame} from one frame to the following needs to be shorter than T_{cross}. For this reason, T_{frame} needs to be equal to Tₑₓₚ to make it compatible that all the molecules are measured and at the same time fluorescence is captured to a maximum extent, which is an issue peculiar to single molecular measurement. However, in general, this condition cannot be satisfied. To satisfy this condition, a time Tₜᵣₐₙₛ for which one frame of image data is transferred to the outside of the element requires to be shorter than the exposure time Tₑₓₚ. When this condition is satisfied, as shown in FIG. 5, the exposure time Tₑₓₚ can coincide with the time T_{frame} of one frame. On the other hand, if the data transfer time Tₜᵣₐₙₛ is longer than the exposure time Tₑₓₚ and if Tₑₓₚ is equal to T_{cross} to obtain the maximum throughput, all the molecules cannot be measured, on the contrary, if T_{frame} is made equal to T_{cross} to measure all the molecules, Tₑₓₚ is smaller than T_{cross}, so that fluorescence cannot be captured from labeled target molecules to a maximum extent to decrease sensitivity. That is to say, if the relation of Tₜᵣₐₙₛ<Tₑₓₚ holds, the minimum value of the exposure time Tₑₓₚ determines the maximum value of average flow velocity, ᵥₘₐₓ is equal to Ls/Tₑₓₚₘᵢₙ. Now, if the number of photo detecting pixels of the line CCD 24 parallel to the flow is taken to be N, the number of photo detecting pixels perpendicular to the flow is taken to be M and the number of data output pixels per second or a data transfer rate is taken to be f(Hz), conditions in which data transfer time is shorter than the exposure time and an average flow velocity is maximized can be represented by the following expression (1):

MN/f≦Tₑₓₚₘᵢₙ. (1)

In the next place, it is ascertained that throughput is maximized when the expression (1) holds and an average flow velocity is at its maximum. The maximum value of the exciting laser power is taken to be Iₘₐₓ (W) and the sensitivity of a system including fluorescent bodies and the detecting system is taken to be a detectable minimum energy density Eₑₓₘᵢₙ (J/mm²). The maximum value ᵥₘₐₓ of an average flow velocity at the time of measuring all molecules needs satisfying 4Iₘₐₓ/(πHᵥₘₐₓ)=Eₑₓₘᵢₙ. Where, reference character H denotes the length of an axis of the cross section in the exciting laser perpendicular to the flow. In addition, if the length of sample flow cell corresponding to one photo detecting pixel of the line CCD 24 parallel to the flow is taken to be 1p and the length corresponding to one photo detecting pixel perpendicular to the flow is taken to be w, the area in the sample flow cell corresponding to the line CCD 24 is S=MNw1p, so that throughput Tp is given by Tp=ᵥM_{w}H. Therefore, the maximum value of throughput is Tp_{MAX}=ᵥₘₐₓM_{w}H=4IₘₐₓW/(πEₓₚₘᵢₙ). Where, W=M_{w} is a length perpendicular to the flow in visual field of the line CCD 24 or a measuring area width. The maximum value of throughput is independent of laser spot size and depends only on Tₑₓₚₘᵢₙ determined by laser intensity Iₘₐₓ, the absorption cross section and luminescent efficiency of a fluorescent body, the quantum efficiency of an optical system and sensitivity of a CCD (minimum light receiving energy) and measuring area width W. This shows that, if the measuring area width W is fixed, throughput can be improved only by changing fluorescent label, the CCD or the brightness of a lens system and maximized by satisfying the expression (1).

In addition, the size w of a photo detecting pixel needs to be nearly equal to the size of a fluorescent image or the wavelength of fluorescence, so that, if the expression (1) is satisfied, throughput is proportional to M. Therefore, N requires to be smaller than M based on the same expression (1). Consequently, the line CCD 24 whose long side is perpendicular to the flow is required as a photo detecting device.

Needless to say, a fluorescent image requires to be obtained in the present invention, so that the number of photo detecting pixels needs to be plural, which requires the line CCD 24 to satisfy the condition given by the following expression (2):

2≦N×M≦Tₑₓₚ×f, M>N. (2)

What is important next is that fluorescence labeled target molecules flow at an average velocity and the average velocity is increased to improve throughput, lowering detectable fluorescent amount, which may result in decrease insensitivity. A condition shown below requires holding for the average velocity of the fluorescence labeled target molecules not to decrease a detectable sensitivity of the fluorescence labeled target molecules.

As is clear from the above description, if the exciting laser beams can be sufficiently finely converged, the best method of maximizing throughput under the condition that the data transfer rate f can hardly be improved is to take N to be 1 (N=1).

Another example of a configuration of a fluorescent detecting device satisfying the condition is shown below. As is the case with the above example, a photo detecting device in the example is composed of a plurality of photo detecting pixels. If an average velocity of fluorescence labeled target molecules in the sample solution flowing through the sample channel section is taken to be v, the length of one side of the photo detecting pixel parallel to the flow velocity is taken to be 1p, the magnification of an optical system for imaging fluorescence generated in the flow cell on the photo detecting device is taken to be m and the number of pixels of the photo detecting device perpendicular to the flow is taken to be N, the following expression (3) requires to be satisfied:

(Ns×1p)/(m×Tₑₓₚ)≦v≦(N×1p)/(m×Tₑₓₚ). (3)

Where, reference numeral ns denotes the average number of pixels obtained when fluorescence labeled target molecules are detected with a plurality of pixels parallel to the flow on the photo detecting device. More specifically, reference numeral ns is a numeric value in which the total half width which is half of the peak value of fluorescent amount around the center of an image of each fluorescence labeled target molecule is expressed by the number of pixels perpendicular to flow velocity. Fluorescence labeled target molecules are observed as spotty images larger in size from an actual molecule also in the direction perpendicular to flow velocity because of Brownian motion during exposure time or imperfect imaging of the above optical system.

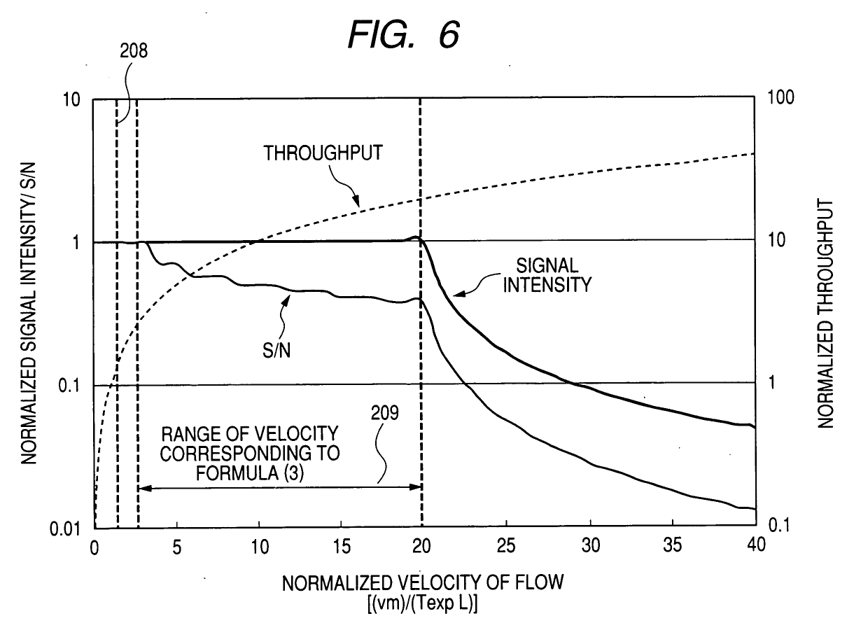

The relationship of an average flow velocity to sensitivity is shown below to explain the meaning of the above conditional (3). In FIG. 6, the average velocity of particles which is normalized so that average velocity at which a molecule travels during an exposure time is made equal to one is expressed by abscissa and throughput is shown in broken line. In addition, a fluorescent detected amount or a signal amount and SN ratio at the time of detecting fluorescence are shown in the figure. Where, throughput, signal amount and SN ratio are numeric values normalized so that a value in which an average velocity of a fluorescence labeled target molecule is one is made equal to one. In addition, a range 209 in FIG. 6 shows a range satisfying the conditions of the expression (3). The range illustrates an average velocity dependency of each amount described above at Ns=3 and N=20. Where, ns=3 is a typical numeric value and generally takes two to several tens. For N=20, it has been selected so that the range of the condition of the expression (3) is easily visible, and it can be selected among from other numbers. A dotted line 208 corresponds to electrophoresis average velocity in the non-patent document 1 and the average velocity shows 1.8.

The throughput shown in FIG. 6 is proportional to the average velocity of fluorescence labeled target molecules. This is because it is presumed that the condition of the expression (2) is satisfied within the range of the average velocity shown in FIG. 6. In general, the condition of the expression (2) is not satisfied at a velocity. At that point, the throughput shows a constant value and does not increase any longer. In other words, it is desirable that the expressions (2) and (3) be satisfied at the same time to realize high throughput.

In the next place, the lower limit of the condition of the expression (3) is described below. This corresponds to the average velocity at which fluorescence labeled target molecules move only by ns-pieces of photo detecting pixels during exposure time. First, the relation between signal amount and average velocity is described. Even if fluorescence labeled target molecules move during exposure time, if the molecules move at such a low velocity as to fall within the area of the sample channel section corresponding to the photo detecting device, all the fluorescent amount detected by a plurality of photo detecting pixels are summed up to obtain a given signal amount. That is to say, signal intensity is kept constant at an average velocity of 20 or less at N=20 in FIG. 6. However, when the upper limit of the condition of the expression (3) is exceeded, all the fluorescence during exposure time cannot be measured, signal sharply drops according as average velocity increases. For this reason, the average velocity of fluorescence labeled target molecules needs to be smaller than the upper limit of the condition of the expression (3). The SN ratio also sharply degrades according as signal intensity decreases when the upper limit of the condition of the expression (3) is exceeded, however, within the range of the condition of the expression (3), the SN ratio obtained for cases where target molecules move at a velocity lower than an average velocity slowly degrades in inverse proportion to square root of average velocity. Where, the SN ratio is defined as the ratio of the above signal intensity to an area where images of fluorescence labeled target molecules do not exist or the standard deviation of fluctuation of background. Increase in average velocity extends the area of fluorescent image, increasing background in proportion to the area, so that the standard deviation of background increases in proportion to the square root of the area. Consequently, the SN ratio decreases in inverse proportion to square root of average velocity.

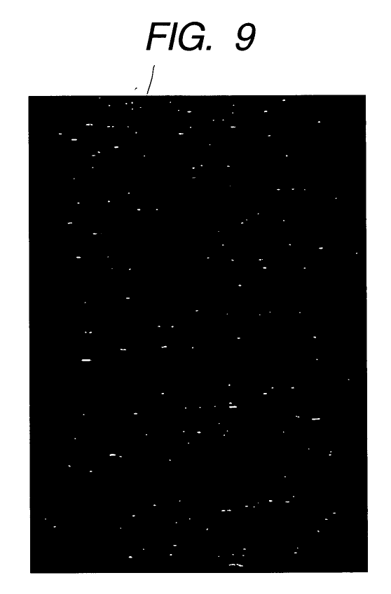

When target molecules are moved at an average velocity less than the lower limit, on the other hand, images of fluorescence labeled target molecules in the optical system are blurred, so that area of image remains unchanged, which does not change the SN ratio. An average velocity in the non-patent document 1 is 1.8 and fluctuation by Brownian motion is 0.3 or less. At this point, the document describes that blurring attributed to the average velocity (or movement in the document) of fluorescence labeled target molecules or Brownian motion (or diffusion in the document) does not cause any problem. For this reason, this shows that the amount of blurring which an image inherently has is larger than the average velocity. Actually, FIG. 9 shows an image measured by an optical system similar to one used in non-patent document 1. The number of average pixels ns is of the order of three to five, which supports the above. In the range of the average velocity in the condition of the expression (3), the SN ratio lowers in inverse proportion to the square root of the average velocity and throughput increases in proportion to the average velocity. Throughput more largely depends on the average velocity, so that total performance as a fluorescent detector, or the number of molecules which can be measured per unit time may be increased.

Actually, M=200, N=200 and C=1.8 in the non-patent document 1, however, if N is taken to be 40, a laser irradiation area can be decreased to ⅕, thereby improving an exciting density by five times. At this point, the SN ratio is improved by √5 times. On the other hand, increasing the average velocity by five times under this condition decreases SN ration by 1/√5, however, this is offset by the effect by which the exciting density is improved to cause the SN ratio not to be changed. Therefore, changing N to 40 from 200 enables average velocity to be improved by five times. The reason this was done is that the effect of improvement in throughput surpasses that of improvement in SN ratio. Incidentally, when the average velocity is increased to exceed the condition (2), the above sensitivity cannot be maintained.

When the average velocity is less than the lower limit in the condition of the expression (3), the same fluorescent body is repetitively excited and deteriorated (fluorescent intensity may be lowered), so that the range of the average velocity is inappropriate for the above reason.

Another example of a configuration for improving throughput is described below. A photo detecting device is composed of a plurality of photo detecting pixels as is the case with the above. If an average velocity of fluorescence labeled target molecules in the sample solution flowing through the sample channel section is taken to be v, the length of one side of the photo detecting pixel parallel to the flow is taken to be 1p and the magnification of an optical system for imaging fluorescence generated in the sample channel section on the photo detecting device is taken to be m, light is detected while transferring electric signals transformed by the photo detecting pixels in time with the average velocity and direction of target molecules line by line. If a time required for moving one pixel of one line is taken to be Tf, the condition for the following expression (4) needs to be satisfied:

V=1p/(m×Tf). (4)

This configuration causes optical detection and data transfer in the photo detecting device to be simultaneously executed in time with the average velocity of fluorescence labeled target molecules. That is to say, detected electric signals are added and moved in time with the movement of fluorescence labeled target molecules, so that all the fluorescence generated when passing through the photo detecting device can be made incident on about ns-pieces of pixels almost irrespective of the average velocity. For this reason, unnecessary background noise will not be captured. That is why throughput can be improved without changing the SN ratio. In other words, the average velocity can be increased without lowering the SN ratio in the range of the average velocity in the condition of the expression (3) shown in FIG. 6. On the contrary, when the data transfer velocity deviates from the target molecule velocity, the images of fluorescence labeled target molecules extend to the direction of the average velocity as the velocity deviates, which increases the image area. For this reason, even though all fluorescence can be measured, background exerts a great influence by increment in the image area, decreasing the SN ratio. On the other hand, a time for transferring data to the outside of the photo detecting device needs to be shorter than the data transfer time between pixels in time with the above flow velocity, so that the condition of the following expression needs to be satisfied.

Tf≧M/f (5)

When the equal sign holds in the expression (5) which maximizes throughput, the condition becomes most preferable. In this configuration, the expression (1) corresponds to the expression (5) and the expression (3) corresponds to the expression (4).

Another example of a configuration for improving throughput is described below. The configuration satisfies at least one of the expressions (2) to (5) and at the same time includes an objective lens which focuses and images fluorescence generated inside the flow cell onto a detecting section, of which the numerical aperture is 0.75 or more.

For a fluorescent label, in general, the number of photons which one fluorescent body can emit is determined by the ratio of its decay sectional area to a light-emitting sectional area. For example, fluorescein isothiocyanate (FITC) emits as few as about 2800 photons. If one labeled particle is imaged on 3×3 pixels, the number of photons will be about 910 per pixel. An SN ratio needs at least 10 or more to measure monomolecule. Even if background light can be neglected and the most sensitive CCD is used as a photo detecting device, there exists its reading noise of about eight photons, so that the efficiency of an objective lens to capture photons requires 10% or more, taking it into account that the quantum efficiency of the photo detecting device is 90% at maximum. A numerical aperture (NA) needs to be 0.6 or more to realize a capturing efficiency of 10% or more.

Yet another example of a configuration for improving throughput is described below. The configuration satisfies the foregoing conditions (1) to (3) and at the same time includes an objective lens for focusing and imaging fluorescence generated inside the flow cell onto a detecting section. If the center wavelength of fluorescence is taken to be λ, the length w/m of the sample channel corresponding to one side of a photo detecting pixel satisfies the following expression (6):

w/m≦λ (6)

In general, the wavelength of a fluorescent label is on the order of 300 nm to 700 nm and the resolution of the above optical system may be almost the same as the wavelength. If the photo detecting pixel is made larger than the resolution of the optical system, one photo detecting pixel is apt to capture more intense background lights except fluorescence, which degrades the SN ratio. For that reason, the expression (6) needs holding.

Still yet another example of configuration for improving throughput includes a flow cell, means for causing uniform sample solution to flow into the flow cell, a light irradiation section for causing exciting light to be incident on the flow cell and a detecting section for detecting fluorescence generated inside the flow cell, satisfies any of the above conditional expressions (2) to (5), causes the detecting section to image fluorescence from fluorescence labeled target molecules and has a particle counting section which is means for counting the number of fluorescence labeled target molecules from the obtained fluorescent intensity distribution image. Where, the fluorescent intensity distribution image means an image that one image corresponding to a photo detecting device is arranged in time series when the image is obtained, or a series of image groups and a group of images subjected to some signal processing.

In this configuration, the particle counting section counts the number of fluorescence labeled target molecules on the basis of the obtained fluorescent intensity distribution image, and the concentration of the target molecules is measured based on the ratio of the number of the fluorescence labeled target molecules to the volume of the sample solution passing through the sample flow cell. A typical method of counting the number of fluorescence labeled target molecules is described in the following. Fluorescence labeled target molecules are expressed by peaks of spotty electric signal values in the fluorescent intensity distribution image. The number of spots having peak values above a fixed threshold is counted to determine the number of fluorescence labeled target molecules.

Another example of a configuration of a fluorescence detection system according to the present invention includes a flow cell, means for causing uniform sample solution to flow into the flow cell, a light irradiation section for causing exciting light to be incident on the flow cell and a detecting section for detecting fluorescence generated inside the flow cell, satisfies conditional expressions (2) to (5) and has an element for separating fluorescence. It is preferable that light different in wavelength be decomposed perpendicularly to the flow velocity by a spectroscopic element.

In another example of a configuration of a fluorescence detection system according to the present invention, a flow cell in the fluorescence detection system, which is so configured to satisfy the above conditional expressions (2) to (5), is a sheath flow cell.

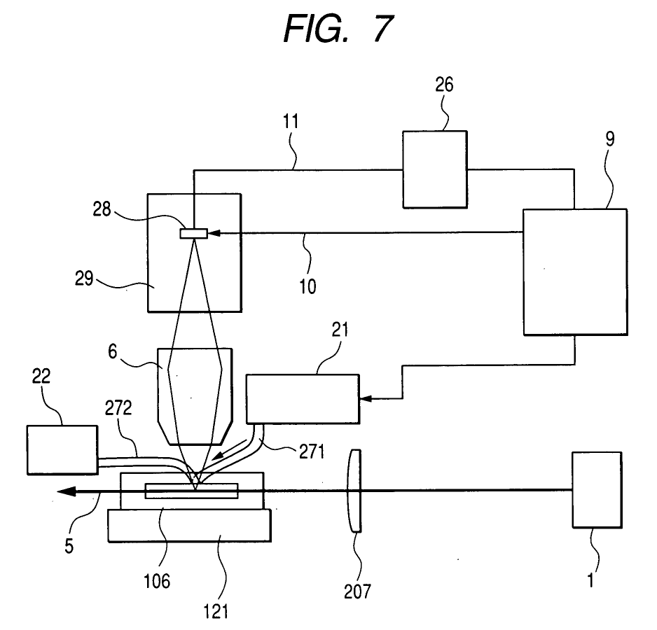

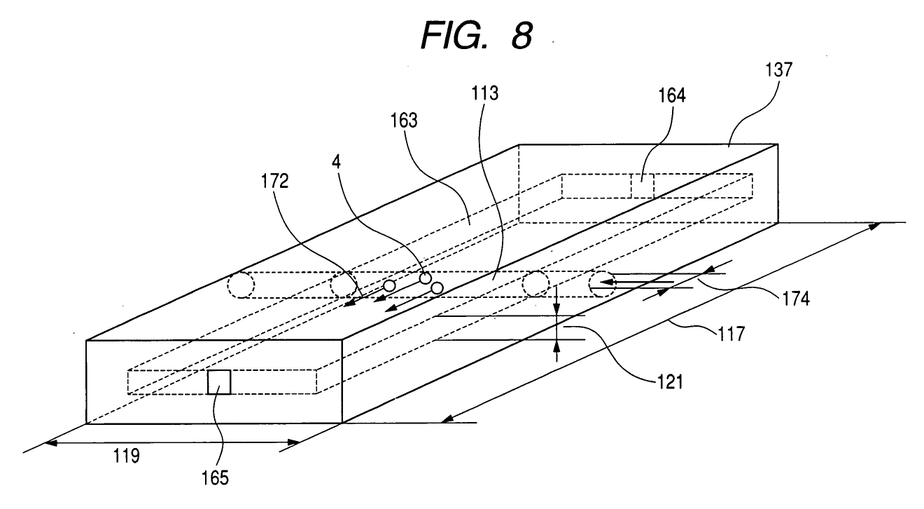

FIG. 7 is a schematic diagram showing another configuration example of a fluorescence measuring instrument according to the present invention. FIG. 8 is a schematic perspective view showing another example of a sample flow cell.

A CCD photo detecting device 28 of this fluorescence detection system satisfies the conditional expression (2). The timing and length of exposure time are controlled by the control system 10 via the signal line 10 to realize a substantially serial exposure as shown in FIG. 5. The area captured by a CCD camera 29 is preferably a rectangle of which short side faces the flow velocity direction. The reason is that M is preferably made large and N is preferably made small in order to satisfy the conditional expression (1) and improve throughput. For the above reason, the shape of the exciting laser beam does not need extend in parallel to the direction in which target molecules move. The beam shape may be circular instead of elliptical, so that the laser beams are focused by the single lens 207. In the CCD photo detecting device 28, the following settings were made; M=100, N=20, f=1 MHz, Texp=18 msec and one frame time=20 msec. The number of photo detecting pixels in the photo detecting section may be set at discretion irrespective of the total number of photo detecting devices. The number of pixels in the photo detecting device may be 1000×500 pixels to realize a photo detecting section with M=100 and N=20.

FIG. 8 is a schematic perspective view showing another example of a flow cell. The flow cell corresponds to reference numeral 106 in FIG. 7. Unlike the flow cell shown in FIG. 4, the flow cell 106 is produced by cutting one quartz substrate 137. The center portion of the quartz substrate 137 is rectangularly cut to form the sample channel 163. The laser beams incident on the flow cell 106 propagate while repeating multiple reflection between the walls of upper and lower sides of the sample channel and excite fluorescent bodies bonded to fluorescence labeled target molecules 4 in the sample solution flowing the sample channel section. This enables an irradiation area to be extended in the direction in which the laser propagates. Fluorescence thus generated is focused by the objective lens 6 and imaged on the rectangular CCD element 28. The rectangular CCD element 28 was arranged with its long side parallel to the direction in which the exciting laser beams are incident so that the photo detecting pixels were arranged perpendicularly to the direction 172 in which the fluorescence labeled target molecules 4 move. Sample solution including labeled target molecules is controlled by the flow velocity controlling section 21 composed of a syringe and a syringe pump to flow along the sample channel 163 at a fixed flow velocity. With the use of such a configuration, fluorescent intensity distribution images are continuously obtained from fluorescence labeled target molecules 4 by the rectangular line CCD element 28 without time loss and these images are arranged in time series to form again the fluorescent intensity distribution images. The number of fluorescent molecules are counted on the basis of the obtained fluorescent intensity distribution images to measure the concentration of the target molecules based upon the ratio of the number of labeled target molecules to the volume of the sample solution passing through the flow cell. Labeled target molecules after having been measured pass through the flow cell and are collected in the foul solution reservoir 22.

The flow cell shown in FIG. 7 is described in detail. The sample channel 163 was set to 25 μm thick so that the exciting laser effectively propagates while repeating multiple reflection between the sample solution and the quartz substrate. Holes are provided as an inlet 164 and an outlet 165 in one of two quartz substrates of the sample channel section. The sample flow cell was set to several mm or more in width 119 so that the laser irradiation area is substantially increased compared with the non-patent document 1. The flow cell was set to several cm in length 121 from the viewpoint of cost and easy-to-handle requirement because the length is determined irrespective of a sample volume to be measured unlike the sample cell.

The exciting laser spot was decreased to 10 μm from 50 μm in width 117 to improve an exciting laser density and throughput by five times respectively.

The present invention is described below based upon specific embodiments.

### First Embodiment

In the present embodiment, the fluorescence detection system shown in FIG. 3 was used. The sample flow cell shown in FIG. 4 was used. The laser beams emitted from the Ar⁺ laser beam source 1 are focused to a spot diameter of 20 μm by the achromatic lens 207 with a focal length of 31 mm. In this state, the laser beams are caused to be incident on the sample flow cell 105 to propagate through the sample channel section 163 between the two quartz substrates 131 and 132 shown in FIG. 4. The laser beams excite labeled target molecules 4 in the sample channel section 163 to generate fluorescence. The sample channel section was set to 50 μm thick so that the exciting laser beams do not scatter at the interface between the substrates 131 and 132 and the solution, and the sample channel section was set to 250 μm wide to improve throughput. The thickness of the sample channel section 163, or the thickness of the dent formed in the substrate 132 was set to 25 μn. The sample flow cell was set to 3.2 mm wide to maintain handling and mechanical strength. Thus, the exciting laser spot width 117 was decreased to 20 μm from 100 μm to improve an exciting laser density and throughput by five times respectively.

Generated fluorescence was imaged on the line CCD element 24 by the objective lens 6 with a magnification of 20 times and a numerical aperture of 0.75. The number of pixels in the line CCD element 24 used is 450 pixels in the direction in which laser beams propagate and 20 pixels in the direction perpendicular thereto. Furthermore, for the 20 pixels, one pixel is subjected to binning in the CCD element so that the number of photo detecting pixels in the line CCD element 24 is equal to 450×1 pixels to output one-dimensional fluorescent image (where, “binning” refers to integration of electric charges corresponding to 20 pixels generated by fluorescence into an electric charge corresponding to one pixel and transfer of it to a data synthesis section 25 through the signal line 11). Labeled target molecules 4 are controlled by the flow velocity controlling section 21 composed of a syringe and a syringe pump to flow along the detecting area at a fixed flow velocity and pass through the sample channel section 163.

Thus, fluorescent data obtained from by the line CCD element 24 without time loss at a fixed flow velocity are arranged in time series to form again a two-dimensional fluorescent image by the data synthesis section 25. The target molecule counting section 26 counts the number of molecules based on the two dimensional fluorescent image thus obtained, which enables measuring the concentration of target molecules based on the ratio of the number of molecules to the volume of the sample solution passing through the flow cell. At this point, the particle counting section 26 performs counting in such a manner as described below. First, there is provided an image shown in FIG. 9 as an example of the two-dimensional image. The image is expressed so that the higher the fluorescent intensity is, the more whitish the image becomes, for this reason, the white dots in the image correspond to labeled target molecules. The black area is background where there is no molecule, however, it emits weak light because laser beams are incident on the sample solution. Its intensity from the sample solution is weaker than fluorescent intensity from fluorescence labeled target molecules, so that it is blackish. The target molecule counting section 26 evaluates the fluorescent intensity of background and counts the number of white spots corresponding to the images of fluorescence labeled target molecules of which difference from the background is greater than a properly determined threshold, thereby realizing counting the number of fluorescence labeled target molecules.

The line CCD element 24 was driven and controlled by a trigger signal from the controlling system 9. The exposure time is 18 msec, data transfer time is 15 msec and processes corresponding to the time are simultaneously executed as shown in FIG. 5. After exposure, it is required to transfer data in the line CCD element 24 to prepare data transfer. It takes 0.5 msec or less to prepare. For this reason, it consumes 2.5% of the total measuring time as loss time during which exposure is not performed, which realizes substantially continuous exposure. The number of photo detecting pixels of the CCD used is M=450, N=20, f=1 MHz and Texp=18 msec, so that MN/f=9 (msec)<Texp, which satisfies the conditional expression (2). In addition, the flow velocity v of the labeled target molecule was set to 500 μm/sec. If this value is transformed into normalized velocity of flow, it becomes 18, which satisfies the conditional expression (3).

FIG. 9 is a fluorescent image of two-dimensional molecule synthesized by the data synthesis section 25. The sample was solution in which a double stranded DNA was labeled by intercalator YOYO-1, the concentration of DNA was 10⁻¹²M, the concentration of YOYO-1 was 10⁻⁹M.

In the method disclosed in the non-patent document 1, the throughput in single molecular measurement is 0.054 μl/minute. It has been verified that the present method has increased throughput to 1.5 μl/minute or more. This is because the flow velocity was increased by about five times and the width of the sample channel section is increased to 50 μm from 250 μm by five times. Needless to say, the number M of photo detecting pixels of the CCD is increased to 450 from 100 to measure the entire sample channel section extended.

### Second Embodiment

In the present embodiment was used the same fluorescence detection system as in the first embodiment. However, in the present embodiment, film is provided on the substrate of the sample flow cell to totally reflect the laser beams. Such a sample flow cell is capable of improving an exciting laser density with respect to the same exciting laser intensity, enabling shortening exposure time to improve throughput. If the conditional expression (2) is satisfied, in particular, the percentage of loss time except exposure time is small during measuring time, so that throughput can be improved in inverse proportion to reduction in exposure time and it is very effective to provide the total reflection film on the substrate constituting the sample flow cell.

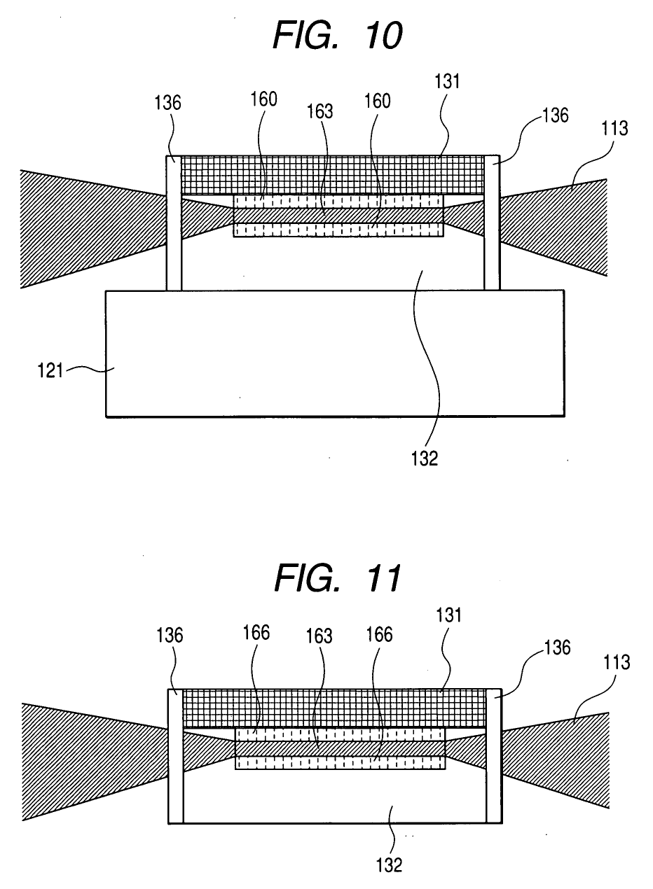

FIG. 10 is a cross section of a configuration of the sample flow cell. Sample solution (sample) flows between the two quartz substrates 131 and 132 and laser beams 113 focused by the achromatic lens 207 are incident on the solution and excite fluorescent labels while propagating. The laser beams are totally reflected at the interface between the two quartz substrates and the solution to propagate in the solution without leaking, which allows the exciting laser intensity density to be improved. A film 160 lower in refractive index than the solution needs to be formed at the area of the sample channel section 163 to realize a total reflection. Fluorocarbon polymer is preferably used as a material low in refractive index. In the present embodiment, amorphous fluoro-polymer with a refractive index of 1.29 was used.

For the range of refractive index, a material low in refractive index applicable to the thin film may be smaller in refractive index by 0.1% or more than the solution and a refractive index may be larger than 1. The upper limit of a refractive index depends on the refractive index of the solution. The solution varies from about 1.33 to 1.37 in refractive index with the concentration of salt or polymer except fluorescence labeled target molecules 4. When a variation in refractive index of the solution is small under use condition, film smaller in refractive index by 0.1% or more than the solution to be used may be formed to cause the exciting laser beams to propagate between the two glass substrates. If the difference in refractive index is 0.1% or less, a condition for laser incidence becomes strict and unrealistic. It is preferable that the difference in refractive index be larger, which stabilizes fluctuation in refractive index of the solution, however, light is inevitably absorbed to attain a refractive index of 1 or smaller in a wavelength range used for exciting fluorescent bodies, so that this is not appropriate. Actually, the range of refractive index is preferably 1.2 to 1.35.

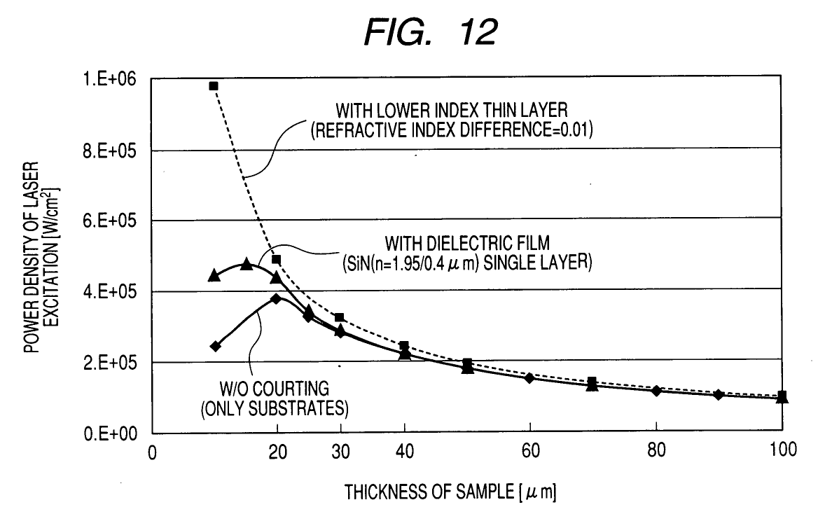

The effect of the low refractive-index thin-film 160 is described with reference to FIG. 12. The graph shows average value of excitation intensity density for cases where the intensity of laser incident on the sample cell is fixed at 10 mW with respect to the thickness of the solution held in the cell. The solid line shows average value of excitation intensity density for cases where the low refractive-index thin-film is not provided. The dotted line shows that for cases where the low refractive-index thin-film is provided. Presumed solution is pure water with a refractive index of 1.33). It can be seen that the thinner the thickness of the solution is, the higher the exciting laser density is. Sensitivity of detecting fluorescent molecules is improved with an increase in exciting laser density. Thinning the thickness of the solution enables relatively reducing the influence of background noise (Raman scattering of water or molecular scattering in the solution) except fluorescence.

Incidentally, in the present embodiment, the thickness (space between the first and second layers which are the low refractive-index thin-film) of the solution held in the sample cell was set to be 15 μm. Excessively thinning the thickness of the sample solution decreases the laser irradiation volume to lower throughput, so that the thickness is preferably 15 μm or more and actually set to be 15 μm. However, a sensitivity of measuring the target becomes high with decrease in thickness of the solution, therefore, so that the thickness is determined according to applications by balance between throughput and fluorescent intensity of fluorescent label.

In addition, a dielectric film (single dielectric layer or multi-layered film) is formed instead of the above low refractive-index thin-film 160 to improve a reflection factor at the interface between the solution and the glass substrates. This is also effective to improve the exciting laser density. FIG. 11 is a cross section of a sample cell using a single dielectric layer as a reflective film, which is the simplest configuration. A dielectric film 166 higher in refractive index than the substrate was formed instead of the above low refractive-index thin-film 160 in FIG. 10. In other words, the first and second dielectric film as thin film was formed on the opposing surfaces of the two substrates.

In this case, total reflection does not occur at the interface between the dielectric thin films 166 and the solution and considerably strong light passes thorough without reflection. The dielectric thin films 166 were set higher in refractive index than the glass substrates 131 and 132, so that total reflection occurs at the interface between the dielectric thin films 166 and the glass substrates 131 and 132. The sample solution is further thinned in thickness to cause light to reflect, which allows providing higher exciting laser density. Data of exciting laser density are shown by plots of black triangles in FIG. 12 for cases where SiN was used as dielectric film (a refractive index of 1.95 and a thickness of 0.4 μm). As can be seen from FIG. 12, the exciting density is lower compared to cases where the low refractive-index thin-film is used, but it is higher compared to cases where only glass is used.

For the range of refractive index of the dielectric thin film, the dielectric thin film needs to be greater in refractive index than the glass substrate, so that refractive index needs to be 1.45 or more if the glass substrate is 1.45 in refractive index. The sample solution is set to be 15 μm thick to obtain good exciting laser intensity. The sample solution ranges from 10 μm to 30 μm in thickness, which is an optimal range. It is to be understood that the dielectric film may be multi-layered. In that case, each dielectric film may be provided with a plurality of dielectric film layers different in refractive index from each other, for example, if each is composed of double layers, the layer contacting the solution may be higher in refractive index than the layer contacting the substrate. When the dielectric film can be most easily multi-layered, a 15-μm thick SiO₂ layer with a refractive index of 1.45 as a cladding layer of which refractive index is well controlled may be interposed between the above dielectric film and the substrate. This provides more stable total reflection.

As a further complicated case, for example, as shown in FIG. 11, a 3.6-μm thick SiN layer with a refractive index of 1.95 is formed on a position 166 and a 3.7-μm thick SiO₂ layer with a refractive index of 1.45 is formed thereon in that order from the glass substrate 132 to hold the solution on the SiO₂ layer. In addition, the same two layers as the above are formed on the surface of the upper other glass substrate in the opposite order. This enables ensuring a reflection factor of 99% or more, improving the exciting laser density. While the above example shows double-layered reflection film as a multi-layered film, the reflection film may be formed by further more layered film.

As described above, an advantage of using the dielectric film is that the surface contacting the solution can be kept stable and unwanted substances are substantially prevented from intermingling into the sample solution.

In FIGS. 10 and 11, a window glass plate 136 is fitted to the part of the sample flow cell where laser beams are incoming using adhesive almost equal to the glass in refractive index. This is because the glass plate 136 is fitted to substantially eliminate irregularity on the sides of the quartz substrates 132 and 131, thereby preventing light incident on the sample flow cell from being scattered by the irregularity and the intensity of light propagating through the solution from deteriorating.

Using the sample flow cell according to the present embodiment improves sensitivity. Using a fluorescent body of the same intercalator YOYO-1 can shorten the exposure time Tₑₓₚ, which improved throughput. Actually, exposure time was 4 msec and data transfer time was 3 msec. The processes corresponding to the times are simultaneously executed as shown in FIG. 5. After exposure, it is required to transfer data in the line CCD element 24 to prepare data transfer. It takes 0.2 msec or less to prepare, which realizes substantially continuous exposure. The number of photo detecting pixels of the CCD used is M=1000, N=20, f=10 MHz, Tₑₓₚ=4 msec, so that MN/f=2 (msec)<Tₑₓₚ, which satisfies the conditional expression (2). The flow velocity of labeled target molecules was set to 2000 μm/sec. Transforming the value into the normalized velocity of flow produces eight, which satisfies the conditional expression (3).

While the throughput of single molecular measurement based on the method disclosed in the non-patent document 1 is 0.054 μl/minute, it was ascertained that the present method increased throughput to 12 μl/minute. This is because flow velocity was increased by about 20 times and the sample channel section was increased to 500 μm from 50 μm by 10 times in width. Needless to say, M was increased to 1000 from 100 to measure the total sample channel section to be extended.

### Third Embodiment

The following is a description on an embodiment in which the conditional expression (3) has held with respect to the number of pixels of a CCD photo detecting device.

The configuration of the fluorescence detection system in the present embodiment is shown in FIG. 3. The laser beams emitted from the Ar⁺ laser beam source 1 are focused to a spot diameter of 25 μm by the achromatic lens 207 with a focal length of 31 mm. In this state, the laser beams are caused to be incident on the flow cell 105 to propagate through the sample channel section 163 between the two quartz substrates 131 and 132 shown in FIG. 4. The laser beams excite labeled target molecules 4 in the sample channel section 163 to generate fluorescence. At this point, in general, there is a relatively great difference in refractive index between the substrates 131 and 132 and the solution, so that the laser beams propagate while repeating multiple reflection between the sample solution and the substrates 131 and 132. The laser beams propagate in the same manner as those in the first embodiment. As described in the first embodiment, the exciting laser intensity density can be maximized when the sample channel section is 25±15 μm thick, so that the sample channel section also in the present embodiment was set to be 20 μm thick. The labeled target molecules 4 are controlled by the flow velocity controlling section 21 composed of a syringe and a syringe pump to flow at a fixed flow velocity, pass thorough the sample channel section 163 and flow into the foul solution reservoir 22.

An image was formed on the rectangular CCD photo detecting pixel device 28 by the objective lens 6 with a numerical aperture of 0.75 and a magnification of 20 times to detect generated fluorescence with a high efficiency.

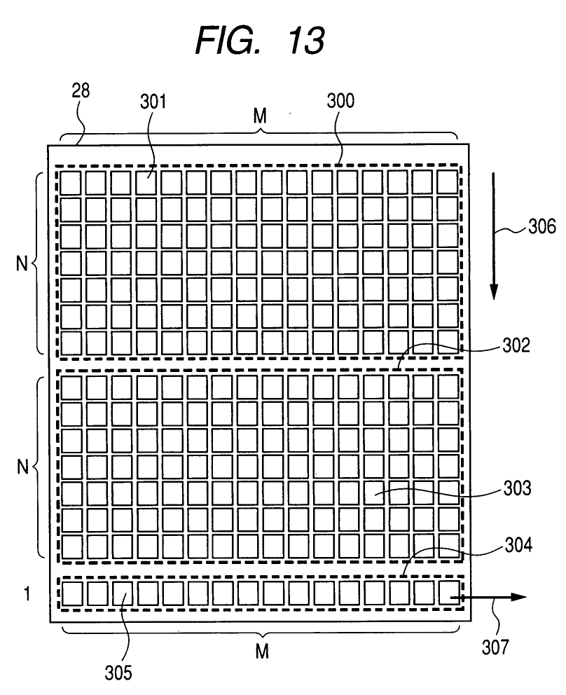

FIG. 13 is a schematic diagram of the photo detecting CCD element 28. An area 300 on the element is a photo detecting section, M-pieces of photo detecting pixels 301 are arranged in the direction parallel to a flow velocity direction 306 and N-pieces thereof are arranged in the direction perpendicular to the direction 306. In the present embodiment, M was set to be 450 and N to be 20. An area 302 on the element is a frame transfer area. The photo detecting pixels transform fluorescence from light into electric signals (electric charge) and thereafter the signals are transferred to the frame transfer area 302 in the chip. At this point, the electric signals transformed from light at the photo detecting section are transferred, pixel by pixel, row by row, at a rate of vertical transfer frequency fv(Hz). Therefore, it takes N/fv (sec) to transfer M×N electric charges on the photo detecting section to the frame transfer area. If N=20 and fv=1 MHz, it takes 20 μsec, which is sufficiently shorter than an exposure time of 18 msec. One frame time was set to be 2 msec, which was given allowance in time. After frame transfer has been finished, the following exposure is started. At the same time, electric charges in the frame transfer area are transferred to a horizontal transfer section 304, row by row. The transferred electric charges are outputted to the outside of the CCD photo detecting device at a pixel clock frequency f, pixel by pixel, in the direction of an arrow 307 in FIG. 13. For this reason, it takes M×N/f (sec) to output fluorescence data detected by M×N-pieces of photo detecting pixels in the photo detecting section to the outside of the CCD photo detecting device.

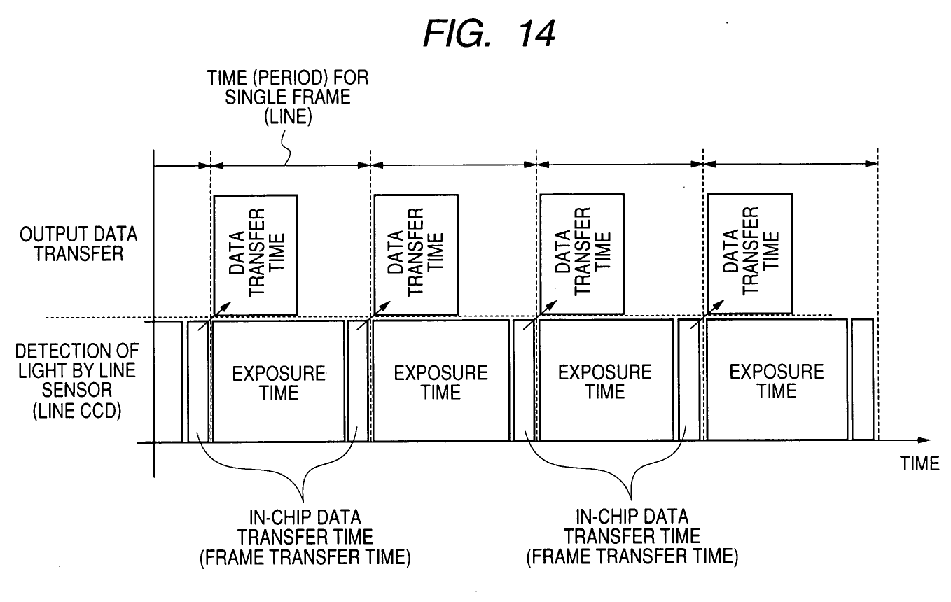

FIG. 14 shows a time table in the present embodiment. Since the condition (1) has already held, the exposure time is longer than the data transfer time to the outside of the photo detecting device. A time required for one frame is given by the sum of the exposure time and the data transfer time (time required for transferring a frame) in the chip. However, as described above, the data transfer time in the chip is sufficiently shorter than the exposure time, so that the time required for one frame is substantially determined by the exposure time.

Furthermore, for 20 pixels, one pixel may be subjected to binning in the CCD element so that the number of photo detecting pixels in the rectangular CCD photo detecting device 28 is equal to 450×1 pixels to output one-dimensional fluorescent image (where, “binning” refers to integration of electric charges corresponding to 20 pixels generated by fluorescence into an electric charge corresponding to one pixel and transfer of it to a data synthesis section 25 through the signal line 11).

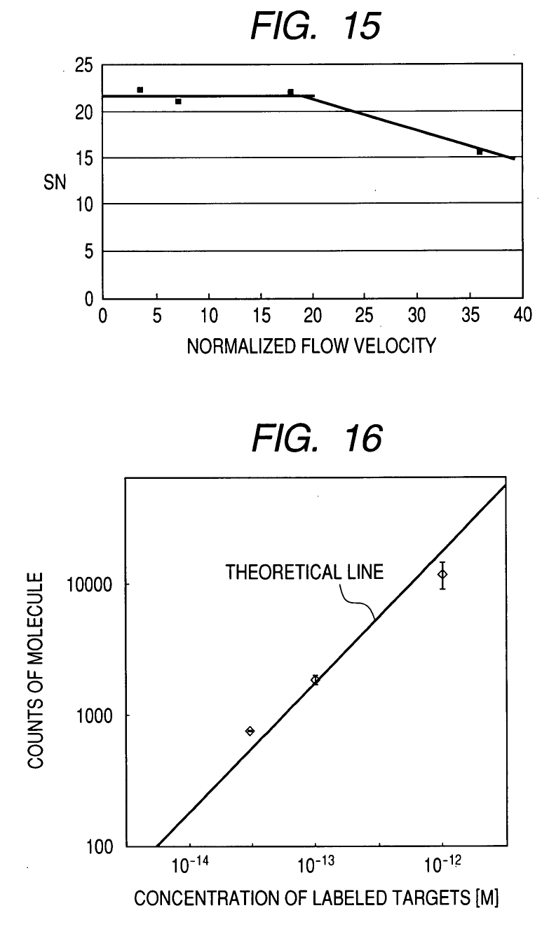

The flow velocity of the sample solution was taken to an average velocity that the sample solution moves by 18 pixels during an exposure time of 18 msec. This average velocity corresponds to a normalized average velocity of 18 in FIG. 6. FIG. 15 shows measurement results on change in SN ratio with respect to the normalized average velocity. As shown in FIG. 6, while the normalized average velocity is rising up to 20, the SN ratio should decrease in inverse proportional to square root of the normalized average velocity. After the normalized average velocity has exceeded 20, the SN ratio should decrease in proportion to the average velocity. In the measurement results also, it was verified that the SN ratios lightly decreased at a normalized average velocity of 20 or less and decreased at the velocity of more than 20.

The following is a description on results obtained by determining concentration using the fluorescence detection system of the present embodiment. Solution in which a double stranded DNA of 3.8 kb is labeled by intercalator YOYO-1 was used as sample solution. Three kinds of solution with a DNA concentration of 10⁻¹⁴M, 10⁻¹³M and 10⁻¹²M were prepared. The number of labeled target molecules was measured while flowing the solution at a normalized average velocity of 18. At this point, a measurement area at the time of measuring using the above optical system was 50 μm×10 μm×20 μm. With this sample volume, only 600 frames were measured. The results are shown in FIG. 16. The theoretical line in the figure shows the number of molecules which is determined by the measurement area, the number of frames and sample concentration. FIG. 16 has proven that the configuration of the present embodiment enables determining concentration from the number of molecules.

In addition, the measurement was conducted at a normalized average velocity of 18, and other parameters used were Ns=3, LP=10 μm, m=20, f=1 MHz, Tₑₓₚ=18 msec, M=450 and N=20, which satisfies the conditional expressions (2) and (3). Consequently, the present embodiment is also an example of a configuration of a fluorescence detection system satisfying the conditional expression (2). The light emitting wavelength of YOYO-1 is 0.51 μm, the magnification of the optical system is 20 times and one side of the pixel is 10 μm long, which satisfies the conditional expression (6).

While the throughput of single molecular measurement based on the method disclosed in the non-patent document 1 is 0.054 μl/minute, it was ascertained that the present method increased throughput to 1.5 μl/minute. This is because the flow velocity was increased by about 5 times and the sample channel section was increased to 250 μm from 50 μm by 5 times in width. Needless to say, M was increased to 450 from 100 to measure the total sample channel section to be extended.

### Fourth Embodiment

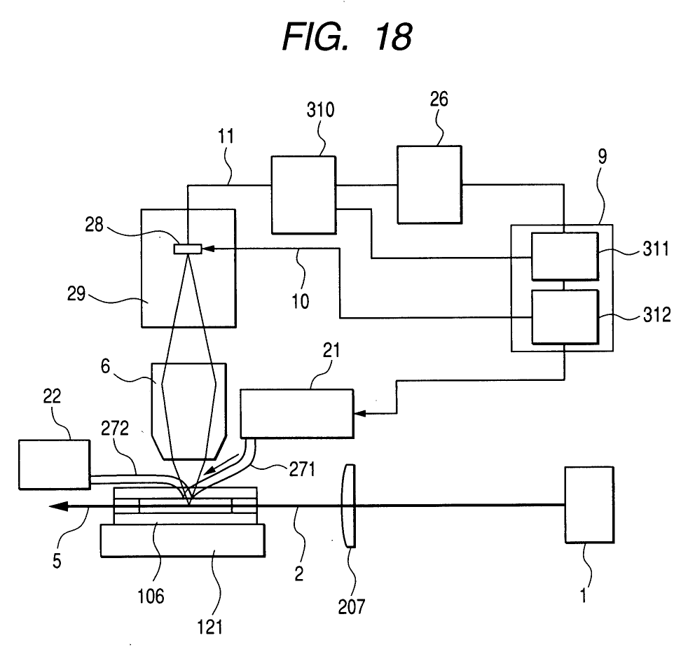

FIG. 18 shows the configuration of a fluorescence detection system according to the present embodiment. The difference in configuration from the fluorescence detection system shown in FIG. 7 is that the fluorescence detection system shown in FIG. 18 is provided with a spot size measuring section 310 and includes a statistical data processing section 311 for processing fluorescent intensity and the number of fluorescence labeled target molecules, and a CCD vertical-transfer synchronizing and uniform-sample flow-velocity control-signal generating section 312, as a function of a control computer 9. In addition, an electric signal transfer control method in the CCD photo detecting device is also different from that in the fluorescence detection system shown in FIG. 7. The differences from the third embodiment are primarily described herein.

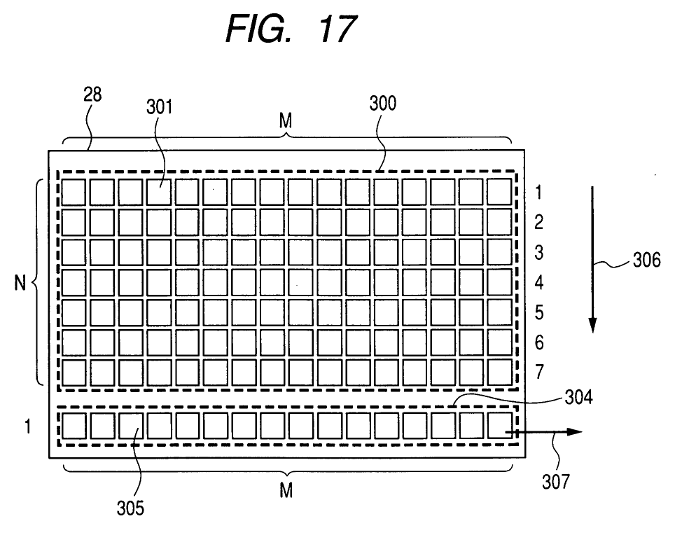

FIG. 17 shows a configuration of pixels in a CCD photo detecting device 28 used in the present embodiment. Reference numeral 300 denotes a photo detecting section composed of M×N-pieces of photo detecting pixels. An arrow 306 shows the direction in which fluorescence labeled target molecules travel. At this point, electric signals transformed from fluorescence are transferred in the direction of the arrow in time with the movement of fluorescence labeled target molecules. The photo detecting pixel received the transferred electric signal transfers the sum of an electric signal transformed by the pixel itself and the electric signal transferred from the pixel immediately above the pixel to the following pixel. For this reason, if the average transfer velocity of the electric signal completely coincides with that of the fluorescence labeled target molecules, all the fluorescence incident on the photo detecting section of the CCD photo detecting device can be caused to be incident on one photo detecting pixel. If a fluorescent image spans a plurality of pixels due to the blur of an optical system, the fluorescent image (spot) will not be enlarged in the same direction as the fluorescent flow velocity by implementing the present embodiment, which maintains the SN ratio constant.

It is extremely difficult to prevent a plurality of fluorescence labeled target molecules from flowing through the sample channel section at a different velocity in the fluorescence detection system of the present embodiment. If a difference is made between the average transfer velocity of the electric signal and the average transfer velocity of fluorescence labeled target molecules, the fluorescent spot is increased in size in the direction of flow velocity, however, the increase can be reduced compared to the cases where the transfer is not conducted, which enables improving the SN ratio.

The important point of the present embodiment is that an average velocity at which fluorescence labeled target molecules different in average velocity can be measured at the highest sensitivity is selected. Two kinds of methods for selecting the optimal average velocity are available. A first method is described below. The size or intensity (peak value or integral value) of an image corresponding to each fluorescence labeled target molecule is measured by the fluorescent spot size and intensity measuring section 310 before counting by the fluorescence labeled target molecules counting section (particle counting section). Data on the size or intensity of an image with respect to a sufficiently large number of fluorescence labeled target molecule are sent to the statistical data processing section 311 in the control computer so that statistical fluctuation is decreased and a control signal is generated by the CCD vertical-transfer synchronizing and uniform-sample flow-velocity control-signal generating section 312 to either minimize the average value of spot size or maximize the average value of fluorescent intensity. The control signals are sent through signal lines 10 and 27. The “vertical transfer” refers to transfer parallel to flow velocity. A second method is described below. After counting by the fluorescence labeled target molecules counting section (particle counting section), the number and the intensity (peak value or integral value) of measured fluorescent spots are sent to the statistical data processing section 311 and a control signal is generated by the CCD vertical-transfer synchronizing and uniform-sample flow-velocity control-signal generating section 312 to maximize the average value of the number and the intensity of fluorescent spots and sent through the signal lines 10 and 27.

More specifically, the vertical transfer is made at a vertical transfer period Tf of 0.2 msec or 5000 pixels/sec and an average moving velocity of fluorescence labeled target molecules is 2.5 mm/sec at this point. For the number of pixels, M is 1000 and N is 20. The pixel clock rate f is 35 MHz. The pixel size was set to be 10 μm and the magnification of the optical system to be 20 times. It is clear from the above that the conditional expression (3) has been satisfied.

The condition required for continuous transfer in the present embodiment is not the expression (2) but the expression (5). N/f μsec is smaller than the vertical transfer period and satisfies the conditional expression (5). In the above vertical transfer configuration, LP/(m×Tf) is 2.5 mm/sec, which makes it clear that the conditional expression (4) is satisfied.

While the throughput of single molecular measurement on the method disclosed in the non-patent document 1 is 0.054 μl/minute, it was ascertained that the present method increased throughput to 15 μl/minute. This is because the flow velocity was increased by about 25 times and the sample channel section was increased to 500 μm from 50 μm by 10 times in width. Needless to say, M was increased to 1000 from 100 to measure the total sample channel section to be extended.

### Fifth Embodiment

The following is a description on an embodiment in which a function of measuring fluorescence wavelength spectrum is added to the fluorescence detection system in FIGS. 1 to 4. According to the present embodiment, fluorescent spectrum from each fluorescent spot can be measured. This allows a plural kinds of target molecules to be simultaneously measured and separately determined. Such a configuration permits a plurality of labeled target molecules to be simultaneously measured to improve throughput.

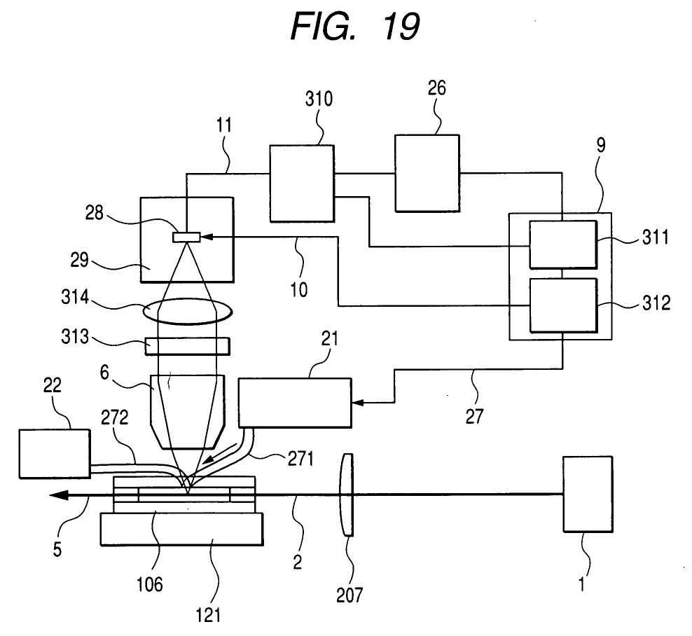

FIG. 19 shows the configuration of a fluorescence detection system according to the present embodiment. Fluorescence from fluorescence labeled target molecules is substantially paralleled by the objective lens 6 and separated by a wavelength dispersion element 313 such as a prism which is inserted into an optical path, and its spectrum is imaged on the CCD detecting element by an imaging lens. In the present embodiment, a spectral direction by wavelength dispersion was set to be substantially perpendicular to the direction of the channel. This causes the direction in which a fluorescent spot extends to be orthogonal to the spectrum direction even if flow velocity increases or a difference is made between transfer velocity and flow velocity, which realizes a good fluorescent-spot spectrum. The direction of wavelength dispersion may be set to be substantially perpendicular to the direction in which exciting light propagates. In this case, fluorescent spectrum from different labeled target molecules decreases in the direction in which exciting light propagates, and fluorescent molecules hardly interfere with each other even if high concentration or a large number of fluorescent molecule images exist on the CCD, which allows accurate measurement. A grating may be used as a wavelength dispersion element instead of a prism.

### Sixth Embodiment

The fluorescence detection system in the present embodiment is totally the same in configuration as that in the first and the fourth embodiment. In the present embodiment, however, a sheath flow cell is used instead of a flow cell.

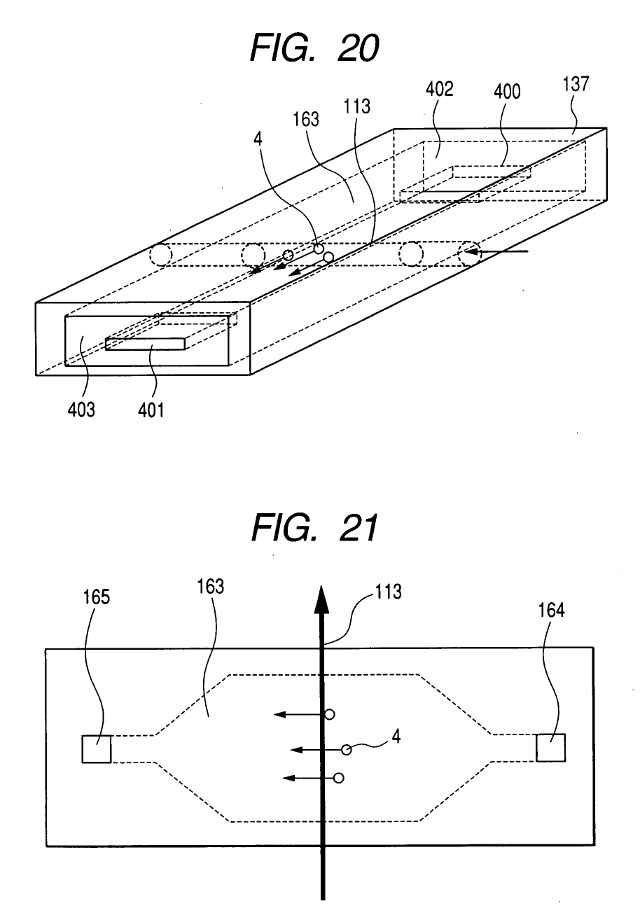

FIG. 20 shows an example of a sheath flow cell. Sheath solution (solvent of sample aqueous solution) is caused to flow around the flow of the sample solution. The sheath flow cell is made of quartz. The outer wall of the sheath flow cell 137 uses a material preferable to radiate exciting light and detect fluorescence at a high sensitivity. A sample solution channel section 163 is provided inside the sheath flow cell. An exciting laser beam 113 is focused by an achromatic lens to propagate into the solution to excite fluorescence labeled target molecules 4, as it the case with the above embodiment. The difference in configuration is that a sample-solution inlet 400 and an outlet 401 are formed in a part of cross section of the sample solution channel section 163 and sheath solution (for example, solvent of sample solution) flows while forming a layer without mixing with the periphery of the sample solution. The sheath solution flows from a sheath solution inlet 402 to a sheath solution outlet 403. The sample solution flows from the inlet 400 to the outlet 401 at a constant velocity without touching the wall surface 163 of the sheath flow cell. The sheath solution is allowed to coincide with the sample solution in velocity at the border of the sample solution and the sample solution is allowed to uniformly flow without having distribution in its cross section.

The sheath flow cell has two advantages: first, fluorescence labeled target molecules in the sample solution in a non-sheath flow cell gradually decreases in velocity according as molecules are located closer to the wall surface, but the sample solution in the sheath flow cell does not contact the wall surface, so that fluorescence labeled target molecules are less distributed in velocity, which allows the sample solution to uniformly flow. In particular, the target molecules of which average velocity and data transfer velocity do not coincide with each other can be decreased. That is to say, sensitivity can be increased to improve throughput as well; secondly, the exciting laser propagating in the flow cell is higher in intensity at a part of the flow cell (normally in the center part) and lowers at the periphery. Fluorescence labeled target molecules flowing at the periphery of the non-sheath flow cell emit weak light, which may lead to imperfect measurement on the molecules. The sheath flow cell can avoid this problem by precluding fluorescence labeled target molecules from existing at parts where the exciting laser is lower in intensity. Furthermore, since the sample solution does not directly contact the wall surface of the sheath flow cell, labeled target molecules do not stick to the wall surface, which eliminates or reduces a cleaning process. The effect of resolution of these problems is conspicuous particularly in single molecular measurement.

In the present embodiment, the sample channel 163 was set to be 100 μm in total thickness and 1 mm in width. The flow of the sample solution was set to 0.5 mm wide and 10 μm thick, this enables the velocity difference of 1 σ in velocity distribution of labeled target molecules to fall within 10% or less. Furthermore, the average of a fluorescent intensity can be increased by about 30% and the dispersion of fluorescent intensity can be decreased.

What is claimed is:

1. A fluorescence detection system comprising:
a flow cell including a flat channel greater in width than in height therein;
a sample solution inlet which introduces sample solution into the flow cell while controlling a flow velocity thereof;
an optical irradiation section which emits exciting light focused into a circular spot substantially perpendicularly to the direction in which the sample solution flows from the widthwise direction of the channel;
a photo detecting device including a rectangular photo detecting section;
an objective lens which forms a fluorescent image produced in the sample solution by irradiating the exciting light on the photo detecting section of the photo detecting device; and
a two-dimensional fluorescent image generating means which coupling the outputs of the photo detecting device in time series to generate a two-dimensional fluorescent image; wherein
M- and N-pieces of photo detecting pixels are arranged along the long and the short side of the rectangular photo detecting section of the photo detecting device respectively, where N is smaller than M and is an integer of 1 or more, and the long side is arranged along the direction in which the exciting light propagates inside the channel,
a time Tᵣₐₙₛ during which data of electric charges transformed from exposure detected by the M- and N-pieces of photo detecting pixels within an exposure time Tₑₓₚ are outputted to the outside of the photo detecting device is shorter than the exposure time Tₑₓₚ of the M- and N-pieces of photo detecting pixels.

2. The fluorescence detection system according to claim 1, wherein the N is two or more, data of electric charges transformed from exposure detected by each of the photo detecting pixels are added by N-pieces of photo detecting pixels themselves adjacent in the direction of the short side and outputted to the outside of the photo detecting device as M×1 pieces of one-dimensional arrangement data, and the two-dimensional fluorescent image generating means arranges the one-dimensional arrangement data in time series in the direction perpendicularly to the arrangement direction to generate a two-dimensional fluorescent image.

3. The fluorescence detection system according to claim 1, wherein the sample solution uniformly flows through the channel.

4. The fluorescence detection system according to claim 1, wherein the objective lens is 0.75 or more in numerical aperture.

5. The fluorescence detection system according to claim 1, wherein if the magnification of the objective lens is taken to be m, the center wavelength of the fluorescence is taken to be λ and a length of the photo detecting pixel perpendicular to the direction in which the sample solution flows is taken to be w, w/m≦λ is satisfied.

6. The fluorescence detection system according to claim 2, wherein the sample solution includes fluorescence labeled molecules and the system comprises counting means which counts the number of fluorescence labeled molecules based on the two-dimensional fluorescent image.

7. The fluorescence detection system according to claim 1, wherein the flow cell includes an inlet for sheath flow which flows while enveloping the sample solution.

8. A fluorescence detection system comprising:
a flow cell including a flat channel greater in width than in height therein;
a sample solution inlet which introduces sample solution containing fluorescence labeled molecules into the flow cell while controlling a flow velocity thereof;
an optical irradiation section which emits exciting light focused into a spot substantially perpendicularly to the direction in which the sample solution flows from the widthwise direction of the channel;
a photo detecting device including a rectangular photo detecting section;
an objective lens which forms a fluorescent image produced in the sample solution by irradiating the exciting light on the photo detecting section of the photo detecting device; and
a two-dimensional fluorescent image generating means which coupling the outputs of the photo detecting device in time series to generate a two-dimensional fluorescent image; wherein
M- and N-pieces of photo detecting pixels are arranged along the long and the short side of the rectangular photo detecting section of the photo detecting device respectively, where N is smaller than M and is an integer of 1 or more, and the long side is arranged along the direction in which the exciting light propagates inside the channel,
the photo detecting device outputs data of electric charges transformed from exposure detected by the M- and N-pieces of photo detecting pixels within an exposure time Tₑₓₚ to the outside of the photo detecting device as one unit, and
if an average velocity of the sample solution flowing through an area in the channel irradiated with the exciting light is taken to be v, the length of the short side of the photo detecting pixel is taken to be 1p, the magnification of the objective lens is taken to be m, and the average of the number of photo detecting pixels is taken to be Ns when one fluorescent label is detected while spanning a plurality of photo detecting pixels to the long-side direction on the photo detecting device, the following condition is satisfied:
(Ns×1p)/(m×Tₑₓₚ)≦v≦(N×1p) (m×Tₑₓₚ).

9. The fluorescence detection system according to claim 8, wherein the N is two or more, data of electric charges transformed from exposure detected by each of the photo detecting pixels are added by N-pieces of photo detecting pixels themselves adjacent in the direction of the short side and outputted to the outside of the photo detecting device as M×1 pieces of one-dimensional arrangement data, and the two-dimensional fluorescent image generating means arranges the one-dimensional arrangement data in time series in the direction perpendicularly to the arrangement direction to generate a two-dimensional fluorescent image.

10. The fluorescence detection system according to claim 8, wherein the sample solution uniformly flows through the channel.

11. The fluorescence detection system according to claim 8, wherein the objective lens is 0.75 or more in numerical aperture.

12. The fluorescence detection system according to claim 8, wherein if the magnification of the objective lens is taken to be m, the center wavelength of the fluorescence is taken to be λ and a length of the photo detecting pixel perpendicular to the direction in which the sample solution flows is taken to be w, w/m≦λ is satisfied.

13. The fluorescence detection system according to claim 9, comprising counting means which counts the number of fluorescence labeled molecules based on the two-dimensional fluorescent image.

14. The fluorescence detection system according to claim 8, wherein the flow cell includes an inlet for sheath flow which flows while enveloping the sample solution.

15. A fluorescence detection system comprising:
a flow cell including a flat channel greater in width than in height therein;
a sample solution inlet which introduces sample solution containing fluorescence labeled molecules into the flow cell while controlling a flow velocity thereof;
an optical irradiation section which emits exciting light focused into a spot substantially perpendicularly to the direction in which the sample solution flows from the widthwise direction of the channel;
a photo detecting device including a rectangular photo detecting section;
an objective lens which forms a fluorescent image produced in the sample solution by irradiating the exciting light on the photo detecting section of the photo detecting device;
a two-dimensional fluorescent image generating means which generates a two-dimensional fluorescent image by arranging one-dimensional arrangement data outputted from the photo detecting device in time series in the direction perpendicularly to the arrangement direction; and
measuring means which measures the size and intensity of fluorescent image in the two-dimensional fluorescent image obtained by the above means; wherein
M- and N-pieces of photo detecting pixels are arranged along the long and the short side of the rectangular photo detecting section of the photo detecting device respectively, where N is smaller than M and is an integer of 1 or more, and the long, side is arranged along the direction in which the exciting light propagates inside the channel,
if there are charges generated by photo detection and photo detecting pixels adjacent to the upstream in the direction of the short side, each of the photo detecting pixels of photo detecting section sequentially transfers electric charges consisting both of an electric charge transferred from the photo detecting pixel adjacent to an upstream and an electric charge generated by the photo detection to the photo detecting pixel adjacent to the downstream in the direction of the short side at a predetermined period and outputs the charges outside the photo detecting device as M×1 pieces of one-dimensional arrangement data, and
the system further comprises flow velocity adjusting means which adjusts the flow velocity of the sample solution by the period and the sample solution inlet based on the size and intensity of fluorescent image in the two-dimensional fluorescent image measured by the measuring means.

16. The fluorescence detection system according to claim 15, wherein if an average velocity of the sample solution of the fluorescence labeled molecules flowing through an area irradiated with the exciting light is taken to be v, the length of the short side of the photo detecting pixel is taken to be 1p, the magnification of the objective lens is taken to be m, the period is taken to be Tf and data transfer velocity from the photo detecting device to the outside is f, the following relation is satisfied:
v≈1p/(m×Tf)
Tf≧M/f

17. The fluorescence detection system according to claim 15, wherein the sample solution uniformly flows through the channel.

18. The fluorescence detection system according to claim 15, wherein the objective lens is 0.75 or more in numerical aperture.

19. The fluorescence detection system according to claim 15, wherein if the magnification of the objective lens is taken to be m, the center wavelength of the fluorescence to be λ and a length of the photo detecting pixel perpendicular to the direction in which the sample solution flows to be w, w/m≦λ is satisfied.

20. The fluorescence detection system according to claim 15 comprising counting means which counts the number of fluorescence labeled molecules based on the two-dimensional fluorescent image.

21. The fluorescence detection system according to claim 15, wherein the flow cell includes an inlet for sheath flow which flows while enveloping the sample solution.
